(19) United States
(12) Patent Application Publication
(10) Pub. No.: US 2025/0231413 A1
(43) Pub. Date: Jul. 17, 2025

(54) MICRO LENS TESSELATION

(71) Applicant: SIGNIFY HOLDING B.V., EINDHOVEN (NL)

(72) Inventors: LUDOVICUS JOHANNES LAMBERTUS HAENEN, SINT OEDENRODE (NL); PETER JOHANNES MARTINUS BUKKEMS, DEURNE (NL); MICHEL CORNELIS JOSEPHUS MARIE VISSENBERG, ROERMOND (NL); OLEXANDR VALENTYNOVYCH VDOVIN, MAARHEEZE (NL)

(21) Appl. No.: 18/854,993

(22) PCT Filed: Apr. 17, 2023
(86) PCT No.: PCT/EP2023/059903

§ 371 Date: Oct. 8, 2024

(30) Foreign Application Priority Data
Apr. 21, 2022 (EP) 22169232.0

(51) Int. Cl. G02B 27/09

(52) U.S. Cl. CPC G02B 27/0961; G02B 27/0916; G02B 27/0927

(57) ABSTRACT

The invention provides a light generating system (1000) comprising a light generating device (100) and a lens-based optical element (400), wherein: the light generating device (100) is configured to generate device light (101); the lens-based optical element (400) comprises a first side (401) configured to receive at least part of the device light (101), and a second side (402), configured downstream of the first side (401), wherein at the first side (401) the lens-based optical element (400) comprises a first arrangement comprising a plurality of first lenses (410), configured in a light-receiving relationship with the light generating device (100), and having first focal distances (f1), wherein at the second side (402) the lens-based optical element (400) comprises a second arrangement comprising a plurality of second lenses (420) configured downstream of the first lenses (410), and having second focal distances (f2): wherein f1<f2, and wherein the following applies: (i) the second lenses (420) are configured in a range of f1+/−20% from the first lenses (410), and (ii) the first lenses (410) are configured external from a range of f2+/−20% from the second lenses (420); and wherein the light generating system (1000) is configured to generate system light (1001) comprising at least part of the device light (101) downstream of the lens-based optical element (400).

### FIELD OF THE INVENTION

The invention relates to a light generating system. The invention further relates to a lighting device comprising such light generating system.

### BACKGROUND OF THE INVENTION

Light generating systems are known in the art. For instance, CN103775977A describes a plastic optical reflecting cover for a tube lamp with a lenticular array on the surface. The plastic optical reflecting cover comprises a lamp assembling port and a light distribution cover, wherein the lamp assembling port is fixed on the bottom end of the light distribution cover, the lenticular array structure is arranged in the light distribution cover, the lenticular array structure is a semispherical structure, a prism structure, a pyramid structure, a rectangular lens structure, a pyramidal structure, a semi-cylindrical structure, a semi-elliptical structure and a parabolic curve structure; the lenticular array structure is distributed in a triangular form, a regular hexagonal form, a rectangular form, a radiative form, a circular form and an elliptical form. By adopting the plastic optical reflecting cover, no optical dead corner exists, the light energy utilization rate is increased, and a purpose for increasing the light emitting efficiency and light emitting uniformity can be realized.

US20150219304A1 discloses a microlens arrangement and illumination device for uniform illumination with microlens arrangement.

### SUMMARY OF THE INVENTION

Depending on the lighting application different beam shapes may be selected. This can change from narrow to broad beam, wall-wash beam to create homogeneous wall illumination, more rectangular beam or even an oval beam. Further, it may be desirable select the cross-sectional shape of a beam, like narrow in one direction or narrow in two orthogonal directions (but other options may also be desirable, e.g. dependent upon the application). Further, it may be desirable to have (relatively) smooth beams. Yet, it appears desirable to reduce glare.

Prior art approaches for beam shaping, such as for providing an oval beam, and such as for providing large light spreading, may result in substantial glare, such as with substantial intensity at angles over 60° or over 65°, which may be undesirable. Further, prior art beam shaping approaches may be relatively thick, such as due to requiring relatively thick collimators. The thickness may result in relatively bulky devices, which may preclude their application in certain applications. Further, prior art approaches may require providing dedicated systems for a particular beam shape.

Hence, it is an aspect of the invention to provide an alternative light generating system, which preferably further at least partly obviates one or more of above-described drawbacks. The present invention may have as object to overcome or ameliorate at least one of the disadvantages of the prior art, or to provide a useful alternative.

According to a first aspect, the invention provides a light generating system comprising a light generating device and a lens-based optical element. Especially, the light generating device may be configured to generate device light. In embodiments, the lens-based optical element may comprise a first side and a second side. The first side may be configured to receive at least part of the device light. The second side may be configured downstream of the first side (with respect to the device light). In embodiments, at the first side, the lens-based optical element may comprise a plurality of first lenses, especially configured in a light-receiving relationship with the light generating device. The plurality of first lenses may especially be configured in a first arrangement. Further, the plurality of first lenses may have first foci (F1) and first focal distances (f1). Similarly, in embodiments, at the second side the lens-based optical element may comprise a plurality of second lenses configured downstream of the first lenses (with respect to the device light). The plurality of second lenses may especially be configured in a second arrangement. Further the plurality of second lenses may have second foci (F2) and second focal distances (f2). Especially, f1<f2. In embodiments, the second lenses may be configured (with)in a range of 0.8*f1-1.2*f1 from the first lenses. In further embodiments, the first lenses may be configured external from a range of 0.8*f2-1.2*f2 from the second lenses. In embodiments, the light generating system may be configured to generate system light comprising at least part of the device light downstream of the lens-based optical element. In specific embodiments, the invention may provide a light generating system comprising a light generating device and a lens-based optical element, wherein: the light generating device is configured to generate device light; the lens-based optical element comprises a first side configured to receive at least part of the device light, and a second side, configured downstream of the first side, wherein at the first side the lens-based optical element comprises a first arrangement comprising a plurality of first lenses, configured in a light-receiving relationship with the light generating device, and having first focal distances (f1), wherein at the second side the lens-based optical element comprises a second arrangement comprising a plurality of second lenses configured downstream of the first lenses, and having second focal distances (f2); wherein f1<f2, and wherein the following applies: (i) the second lenses are configured in a range of 0.8*f1-1.2*f1 from the first lenses, and (ii) the first lenses are configured external from a range of 0.8*f2-1.2*f2 from the second lenses; and wherein the light generating system is configured to generate system light comprising at least part of the device light downstream of the lens-based optical element.

In particular, the lens-based optical element may comprise strong first lenses at the first side and weak(er) second lenses at the second side. The distance of these second lenses towards the first lenses at which glare is reduced most without too much influence on final beam-shape may depend on the refractive index of the transparent optical material, and on the pitch of the first and/or second lenses. In particular, the first lenses may be mainly responsible for the spreading of the light, while with the second lenses the glare may be controlled. The glare control may work best if the second lenses are arranged at (about) the focal point of the first lenses. With the strength of the second lenses this glare reduction can be controlled. If they are (relatively) too weak, too little glare reduction may be achieved. If they are (relatively) too strong, the beam-shape will be sharper and can be too sharp if a smooth beam is required. The first lenses may provide a beam shaping effect, whereas the second lenses may primarily provide a glare reduction effect. In particular, positioning the first lenses towards the light generating device, i.e., upstream of the second lenses, may improve beam control and efficiency. In particular, the lens-based optical element of the invention may enable providing a sharp cut-off of beam angle, such as at FWHM, or such as at WF10% M. Further, the lens-based optical element of the invention may facilitate modularity as different beam shapes may be provided without requiring dedicated spots. In particular, one may start with a source, primary optics like reflector or collimators to make a narrow round beam and after this the lens-based optical element may be added to re-shape the beam towards a desired beam shape.

For instance, with embodiments of the invention, glare above 60° may be reduced with a factor 3 while maintaining the bandwidth of the system light, and while maintaining the intensity of the system light below 60°. The term “bandwidth” may especially refer to the FWHM (Full Width Half Maximum) or the FW_10% (Full Width at 10% of maximum). In particular, with embodiments of the invention FWHM and FW_10% can be maintained while light in the glare region (above 60°) may be reduced.

Hence, the invention may provide a light generating system. The light generating system may especially be configured to provide system light. The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In embodiments, the light generating system may comprise a light generating device. In particular, the light generating device may be configured to provide device light. In embodiments, the system light may (at least partially) be made up of the device light. In particular, the device light may pass through one or more optical elements, including the lens-based optical element, and be provided as (part of) the system light. The light generating device may especially be configured to provide the device light, optionally via one or more optical elements, to the lens-based optical element.

The light generating system may, in embodiments, further comprise the lens-based optical element. The lens-based optical element may especially be arranged in a light-receiving relationship with the light generating device. In particular, the lens based-optical element may be configured to receive device light from the light generating device.

The lens-based optical element may especially have a first side and a second side. The first side and the second side may especially be arranged opposite of one another. In embodiments, the first side may be configured to receive (at least part of) the device light. The second side may especially be configured downstream from the first side. Hence, the light generating device may provide device light to the lens-based optical element, wherein (at least part of) the device light first passes through the first side and then through the second side of the lens-based optical element.

In embodiments, the lens-based optical element may at the first side comprise (a first arrangement comprising) a plurality of first lenses. The first arrangement, especially the first lenses, may be configured in a light-receiving relationship with the light generating device. The first lenses may especially have first foci F1. In particular, the first foci F1 may be arranged at first focal distances f1 (or “first focal lengths”) from the first lenses. Hence, the first lenses may have first focal distances f1.

In embodiments, the lens-based optical element may at the second side comprise (a second arrangement comprising) a plurality of second lenses. The second arrangement, especially the second lenses, may be configured downstream of the first arrangement, especially of the first lenses, particularly with respect to the device light. The second lenses may especially have second foci F2. In particular, the second foci F2 may be arranged at second focal distances f2 (or “second focal lengths”) from the second lenses. Hence, the second lenses may have second focal distances f2.

Therefore, in embodiments the first arrangement comprising first lenses may comprise a first 2D array of first lenses, and the second arrangement comprising second lenses may comprise a second 2D array of second lenses.

In particular, the first focal distances f1 may be smaller than the second focal distances f2, i.e., the first lenses may be stronger lenses than the second lenses. The second lenses may especially be arranged (about) in focus of the first lenses. Further, the first lenses may especially be arranged (substantially) out of focus of the second lenses.

In embodiments, the first arrangement and the second arrangement, especially the first lenses and the second lenses, may be arranged at a distance selected from the range of f1+/−40%, i.e., at a distance selected from the range of 0.6*f1-1.4*f1. In further embodiments, the first arrangement and the second arrangement, especially the first lenses and the second lenses, may be arranged at a distance selected from the range of f1+/−30%, especially at a distance selected from the range of f1+/−20%, such as at a distance selected from the range of f1+/−10%. In further embodiments, the first lenses and the second lenses may be arranged at a distance selected from the range of f1+/−5%, such as at a distance selected from the range of f1+/−3%.

In further embodiments, the first arrangement and the second arrangement, especially the first lenses and the second lenses, may be arranged at a distance external from the range of f2+/−40%, i.e., at a distance external from the range of 0.6*f2-1.4*f2. In further embodiments, the first arrangement and the second arrangement, especially the first lenses and the second lenses, may be arranged at a distance external from the range of f2+/−30%, especially at a distance external from the range of f2+/−20%, such as at a distance external from the range of f2+/−10%. In further embodiments, the first lenses and the second lenses may be arranged at a distance external from the range of f2+/−5%, such as at a distance external from the range of f2+/−3%.

In particular, in embodiments, the first arrangement and the second arrangement, especially the first lenses and the second lenses, may be arranged at a distance selected from the range of ≤0.97*f2, such as from the range of ≤0.95*f2, especially from the range of ≤0.9*f2. In further embodiments, the first arrangement and the second arrangement, especially the first lenses and the second lenses, may be arranged at a distance selected from the range of ≤0.8*f2, such as from the range of ≤0.7*f2, especially from the range of ≤0.6*f2.

As described above, the light generating system may be configured to provide system light. In particular, in embodiments, the light generating system may be configured to generate system light comprising at least part of the device light downstream of the lens-based optical element.

The shapes of the first lenses and the second lenses may be selected in view of a beam shaping objective.

For instance, in embodiment, the first lenses may comprise linear lenses to substantially provide beam shaping in a single direction. In particular, linear lenses may be particularly suitable if only spreading in one direction is required and the beam width in the other direction (90° rotated) is already suitable. In such embodiments, the second lenses may especially (also) comprise linear lenses. Hence, in embodiments, the first arrangement may comprise a plurality of first linear lenses, and the second arrangement may comprise a plurality of second linear lenses. In particular, in such embodiments, the first (linear) lenses and the second (linear) lenses may be arranged optically aligned (to each other).

In further embodiments, the first arrangement may comprise a (first) 2D array of first lenses (or “first lenslets”), and the second arrangement may comprise a (second) 2D array of second lenses (or “second lenslets”). In particular, in embodiments, the first arrangement, especially the first 2D array, may comprise a tessellating grid of first lenses. Similarly, in embodiments, the second arrangement, especially the second 2D array, may comprise a tessellating grid of second lenses.

In further embodiments, the first lenses may comprise hexagonal lenses. Similarly, in such embodiments, the second lenses may comprise hexagonal lenses. For instance, in further embodiments, the first arrangement ma comprise hexagonal lenses rotated relative to one another. In further embodiments, the first lenses and the second lenses may be rotated relative to one another. Such arrangement may provide a round beam.

In further embodiments, the first arrangement may comprise a sunflower tessellation of lenses. Similarly, in further embodiments, the second arrangement may comprise a sunflower tessellation of lenses.

In further embodiments, the first arrangement may comprise a tessellation of (approximately) round lenses. Similarly, in embodiments, the second arrangement may comprise a tessellation of (approximately) round lenses).

In further embodiments, the first arrangement, especially the first 2D array, may comprise a plurality of lenslets arranged according to a first pitch along a first direction and a second pitch along a second direction, wherein the first pitch and the second pitch differ. Such an arrangement may facilitate providing an asymmetric beam shape, even if the (first) lenslets are symmetric. In further embodiments, the first direction and the second direction may be orthogonal directions.

The first arrangement and the second arrangement, especially the first lenses and the second lenses, may especially be aligned. In particular, the first side and the second side of the lens-based optical element may be arranged in parallel. In particular, the alignment may facilitate providing a beam centered around the optical axis of the lens-based optical element.

In further embodiments, the first lenses and the second lenses may have (essentially) the same shapes. However, in further embodiments, the first lenses and the second lenses may vary in shape. For example, in embodiments, the lens-based optical element may comprise hex-shaped first lenses and rectangular-shaped second lenses. A variation in lens shapes between the first and second lenses may facilitate providing aspect conversion, which may, for instance, be desired of an incoming beam of (collimated) light source light is not rotationally symmetric.

In embodiments, the first lenses may have first optical axes O1 and the second lenses may have second optical axes O2. In particular, the lens-based optical element may comprise a plurality of sets (or “pairs”) of each a first lens and a respective associated second lens, with coinciding optical axes O1,O2. Hence, first lenses of the first arrangement may be paired with (respective) second lenses of the second arrangement.

It may be beneficial for the strength of the first lenses to vary within the first arrangement. For instance, for a lens-based optical element to be applied as a reflector it may be beneficial for the central first lenses to be stronger than the peripheral first lenses. In contrast, for a lens-based optical element to be applied as a collimator it may be beneficial for the central first lenses to be weaker than the peripheral first lenses.

Hence, the first lenses mutually have radially varying first focal distances f1, i.e. the first focal distances of the first lenses mutually vary with varying radial distance from the optical axis O3. In embodiments, the first focal distances f1 may decrease with increasing distance from an optical axis O3 of the lens-based optical element. Alternatively, in embodiments, the first focal distances f1 may increase with increasing distance from an optical axis O3 of the lens-based optical element.

The optical axis O3 is an optical axis O3 of the lens-based optical element. In embodiments, the lens-based optical element may have an axis of symmetry. In such embodiments, the optical axis O3 and the axis of symmetry may substantially coincide. Further, an optical axis of the light generating device may substantially coincide with the optical axis O3.

The radially varying first focal distances may vary in a stepwise or (substantially) continuous fashion.

As, in embodiments, the first focal distances of the first lenses mutually vary with varying radial distance from the optical axis O3, or in other words, the first focal distances f1 of the first lenses may vary radially, and as the second lenses may be arranged at or near the first focal distances f1 of the (respective) first lenses, the lens-based optical element may (also) have a radially varying thickness. In particular, in embodiments wherein the first focal distances f1 increases with distance to the optical axis O3, the thickness of the lens-based optical element may also increase with distance to the optical axis O3. Similarly, in embodiments wherein the first focal distances f1 decreases with distance to the optical axis O3, the thickness of the lens-based optical element may also decrease with distance to the optical axis O3. Especially, in embodiments, the thickness of the lens-based optical element may vary proportionally with the varying first focal distances (f1)

In contrast, in embodiments, the second focal distances (f2) may be (essentially) constant. Hence, in embodiments, the second focal distances (f2) of second lenses may vary ≤15%, such as ≤10%, especially ≤5%, such as ≤3%, including (essentially) 0%.

Hence, in embodiments, the first arrangement may comprise a first lens region comprising a first subset of first lenses and a second lens region comprising a second subset of first lenses, wherein the first subset of first lenses have first region focal distances fr1, and wherein the second subset of first lenses have second region focal distances fr2, wherein fr1 differs from fr2, such as wherein fr1<fr2, especially wherein fr1≤0.9*fr2, or such as wherein fr2<fr1, especially wherein fr2≤0.9*fr1. In further embodiments, the first lens region may be a central lens region of the first arrangement, whereas the second lens region may be a peripheral region of the first arrangement.

In further embodiments, for each lens of the first lenses may apply that the first focal distance f1 of the lens is a function of the axial distance of the lens to the optical axis O3 of the lens-based optical element.

In specific embodiments, the lens-based optical element may be an extruded body. In further specific embodiments, the lens-based optical element may be cast.

The light generating device may comprise a light source configured to provide light source light, especially device light. In particular, the light generating device may comprise a plurality of light sources configured to provide light source light, or especially to (together) provide the device light.

A light generating device may especially be configured to generate device light. Especially, the light generating device may comprise a light source. The light source may especially configured to generate light source light. In embodiments, the device light may essentially consist of the device light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, a LED (light emissive diode). In a specific embodiment, the light source comprises a solid state LED light source (such as a LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be outer surface of the glass or quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. . . . The term “light source” may also refer to an organic light-emitting diode (OLED), such as a passive-matrix (PMOLED) or an active-matrix (AMOLED). In a specific embodiment, the light source comprises a solid-state light source (such as a LED or laser diode). In an embodiment, the light source comprises a LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as a LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as a LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The “term light source” may (thus) in embodiments also refer to a light source that is (also) based on conversion of light, such as a light source in combination with a luminescent converter material. Hence, the term “light source” may also refer to a combination of a LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like a LED, and an optical filter, which may change the spectral power distribution of the light generated by the light source. Especially, the “term light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a diode laser, or a superluminescent diode.

Hence, in embodiments, the light generating device may comprises one or more solid state light sources. In further embodiments, the light generating device comprises one or more LEDs and/or one or more laser diodes.

In further embodiments, the light generating device may be configured to provide the light source light (to the lens-based optical element) at a beam angle ≤45° (at FWHM), such as ≤40°, especially ≤35°. In further embodiments, the light generating device may be configured to provide the light source light (to the lens-based optical element) at a beam angle ≥5° (at FWHM), such as ≥10°, especially ≥15°. In further embodiments, the light generating device may be configured to provide the light source light (to the lens-based optical element) at a beam angle ≥20° (at FWHM), such as ≥25°, especially ≥30°.

Therefore, the light generating device may be configured to provide the device light (to the lens-based optical element) at a beam angle ≤45° (at FWHM), such as ≤40°, especially ≤35°. In further embodiments, the light generating device may be configured to provide the device light (to the lens-based optical element) at a beam angle ≥5° (at FWHM), such as ≥10°, especially ≥15°. In further embodiments, the light generating device may be configured to provide the device light (to the lens-based optical element) at a beam angle ≥20° (at FWHM), such as ≥25°, especially ≥30°.

In yet further specific embodiments, the light generating device in combination with a collimator configured downstream of the light generating device and upstream of the lens-based optical element (see further also below), may be configured to provide the device light (to the lens-based optical element) at a beam angle ≤45° (at FWHM), such as ≤40°, especially ≤35°. In further embodiments, the light generating device in combination with the collimator may be configured to provide the device light (to the lens-based optical element) at a beam angle ≥5° (at FWHM), such as ≥10°, especially ≥15°. In further embodiments, the light generating device in combination with the collimator may be configured to provide the device light (to the lens-based optical element) at a beam angle ≥20° (at FWHM), such as ≥25°, especially ≥30°.

As described above, the light generating system of the invention may provide (relatively) low glare, especially at angles >60°, such as at angles >65°. Such a light generating systems may be particularly suitable for lighting in professional settings, such as in offices. In such settings, white light may be preferred.

For instance, by replacing a conventional lens-based optical element in a prior art light generating system with the herein proposed lens-based optical element, glare at 60° and higher was reduced from 70 cd/klm to 18 cd/klm.

In embodiments, the light generating device may be configured to generate white device light. The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

In embodiments, the light generating system may further comprise a collimator configured downstream of the light generating device and upstream of the lens-based optical element. Especially, the collimator may be configured to provide collimated device light to (the first side of) the lens-based optical element. Hence, the light generating device may be configured to provide device light to the lens-based optical element via the collimator. In particular, as the lens-based optical element may contribute to beam-shaping, a collimator may be relatively thin.

In further embodiments, the collimator may comprise an (off-axis) parabolic mirror. In further embodiments, the collimator may comprise a compound parabolic concentrator. A compound parabolic mirror may facilitate providing (essentially) the same angle distribution over a large area.

In embodiments, the light generating system may be configured to generate a beam of system light, wherein the beam has two orthogonally configured full width half maxima (FWHM) and a beam axis (O4). In embodiments, at least one of the full width half maxima may have a beam angle (α1) selected from the range of at maximum 80°, especially at maximum 75°, such as at maximum 70°, especially at maximum 65°. In embodiments, at least one of the full width half maxima may have a beam angle (α1) selected from the range of at maximum 60°, especially at maximum 55°, such as at maximum 50°, especially at maximum 45°. In embodiments, the at least one of the full width half maxima may have a beam angle (α1) selected from the range of at maximum 40°, such as at maximum 35°, especially at maximum 30°.

In further embodiments, the other of the full width half maxima may (also) have a beam angle (α2) selected from the range of at maximum 80°, especially at maximum 75°, such as at maximum 70°, especially at maximum 65°. In further embodiments, the other of the full width half maxima may (also) have a beam angle (α2) selected from the range of at maximum 60°, especially at maximum 55°, such as at maximum 50°, especially at maximum 45°. In further embodiments, the other of the full width half maxima may (also) have a beam angle (α2) selected from the range of at maximum 40°, such as at maximum 35°, especially at maximum 30°. Hence, the beam may be (relatively) narrow in both orthogonal directions.

In further embodiments, the other of the full width half maxima may (also) have a beam angle (α2) selected from the range of at minimum 45°, especially at minimum 50°, such as at minimum 55°. Hence, the beam may be (relatively) narrow in one direction, but may be (relatively) wide in a second direction (orthogonal to the one direction). Such embodiments may be particularly relevant in the context of linear light sources.

In embodiments, the light generating system may be configured to generate a beam of system light, wherein the beam has two orthogonally configured full width 10% maximum (FW10% M) and a beam axis (O4). In embodiments, at least one of the FW10% M may have a beam angle (β1) selected from the range of at maximum 110°, especially at maximum 105°, such as at maximum 100°, especially at maximum 95°. In embodiments, at least one of the FW10% M may have a beam angle (β1) selected from the range of at maximum 90°, especially at maximum 85°, such as at maximum 80°, especially at maximum 75°. In embodiments, the at least one of the FW10% M may have a beam angle (β1) selected from the range of at maximum 70°, such as at maximum 60°, especially at maximum 50°.

In embodiments, the light generating system may be configured to generate a beam of system light, wherein the beam has two orthogonally configured full width 10% maximum (FW10% M) and a beam axis (O4). In embodiments, the other of the FW10% M may have a beam angle (β2) selected from the range of at maximum 110°, especially at maximum 105°, such as at maximum 100°, especially at maximum 95°. In embodiments, the other of the FW10% M may have a beam angle (β2) selected from the range of at maximum 90°, especially at maximum 85°, such as at maximum 80°, especially at maximum 75°. In embodiments, the other of the FW10% M may have a beam angle (β2) selected from the range of at maximum 70°, such as at maximum 60°, especially at maximum 50°.

The beam axis O4 or optical axis may especially define an interception of the two orthogonal planes that may be used to define the full width half maxima. Note that the beam angles are identical in both orthogonal directions in the case of a rotational symmetric beam. The beams of system light may be rotational symmetric or may not be rotational symmetric. Especially, in embodiments the beam of system light may have at least two orthogonal mirror planes.

Especially, the beam angle may be defined as the angle between two directions opposed to each other over the beam axis for which the luminous intensity is half that of the maximum luminous intensity.

In a further aspect, the invention may provide the lens-based optical element as such. Hence, in an aspect the invention provides a lens-based optical element comprising a first side (configured to receive light, such as from the light generating device as described herein), and a second side, configured downstream of the first side, wherein at the first side the lens-based optical element comprises a first arrangement comprising a plurality of first lenses (which in operation may especially be configured in a light-receiving relationship with the light generating device), and having first focal distances (f1), wherein at the second side the lens-based optical element comprises a second arrangement comprising a plurality of second lenses configured downstream of the first lenses, and having second focal distances (f2); wherein f1<f2, and wherein the following applies: (i) the second lenses are configured in a range of 0.8*f1-1.2*f1 from the first lenses, and (ii) the first lenses are configured external from a range of 0.8*f2-1.2*f2 from the second lenses.

In a further aspect, the invention may further provide a lighting device comprising the light generating device of the invention. In embodiments, the lighting device may especially be selected from the group of a lamp, a luminaire, a projector device, a disinfection device, a photochemical reactor, and an optical wireless communication device. In further embodiments, the lighting device may especially comprise a lamp or a luminaire.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

As indicated above, the lighting unit may be used as backlighting unit in an LCD display device. Hence, the invention also provides an LCD display device comprising the lighting unit as defined herein, configured as backlighting unit. The invention also provides in a further aspect a liquid crystal display device comprising a back lighting unit, wherein the back lighting unit comprises one or more light generating systems as defined herein.

The light generating system may further comprise (other) optics (see also above). The term “optics” may especially refer to (one or more) optical elements. The optics may include one or more or mirrors, reflectors, collimators, lenses, prisms, diffusers, phase plates, polarizers, diffractive elements, gratings, dichroics, arrays of one or more of the afore-mentioned, etc. Alternatively or additionally, the term “optics” may refer to a holographic element or a mixing rod. In embodiments, the optics may include one or more of beam expander optics and zoom lens optics. See further above for examples of optics.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

The terms “violet light” or “violet emission” especially relates to light having a wavelength in the range of about 380-440 nm. The terms “blue light” or “blue emission” especially relates to light having a wavelength in the range of about 440-495 nm (including some violet and cyan hues). The terms “green light” or “green emission” especially relate to light having a wavelength in the range of about 495-570 nm. The terms “yellow light” or “yellow emission” especially relate to light having a wavelength in the range of about 570-590 nm. The terms “orange light” or “orange emission” especially relate to light having a wavelength in the range of about 590-620 nm. The terms “red light” or “red emission” especially relate to light having a wavelength in the range of about 620-780 nm. The term “pink light” or “pink emission” refers to light having a blue and a red component. The term “cyan” may refer to one or more wavelengths selected from the range of about 490-520 nm. The term “amber” may refer to one or more wavelengths selected from the range of about 585-605 nm, such as about 590-600 nm. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In embodiments, the control system may be configured to control the light generating device. In specific embodiments, wherein the light generating device may comprise a plurality of light sources, the control system may control two or more light sources individually and/or may control two or more sets, of each at least one light source, individually. In specific embodiments, wherein the term “light generating device” may refer to a plurality of light generating devices, the control system may be configured to control the light generating device. In specific embodiments, wherein the light generating device may comprise a plurality of light generating devices, the control system may control two or more light generating devices individually and/or may control two or more sets, of each at least one light generating device, individually.

In yet a further aspect, the invention also provides a lamp or a luminaire comprising the light generating system as defined herein. The luminaire may further comprise a housing, optical elements, louvres, etc. etc. . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a lighting device selected from the group of a lamp, a luminaire, a projector device, a disinfection device, a photochemical reactor, and an optical wireless communication device, comprising the light generating system as defined herein. The lighting device may comprise a housing or a carrier, configured to house or support, one or more elements of the light generating system. For instance, in embodiments the light generating device may comprise a housing or a carrier for one or more of the light generating system and the lens-based optical element.

Instead of the terms “lighting device” or “lighting system”, and similar terms, also the terms “light generating device” or “light generating system”, (and similar terms), may be applied. A lighting device or a lighting system may be configured to generate device light (or “lighting device light”) or system light (“or lighting system light”). As indicated above, the terms light and radiation may interchangeably be used.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an embodiment of the light generating system.

FIG. 2A-D schematically depict embodiments of the lens-based optical element.

FIG. 3 schematically depicts an embodiment of the lighting device. The schematic drawings are not necessarily to scale.

### DETAILED DESCRIPTION OF THE EMBODIMENTS

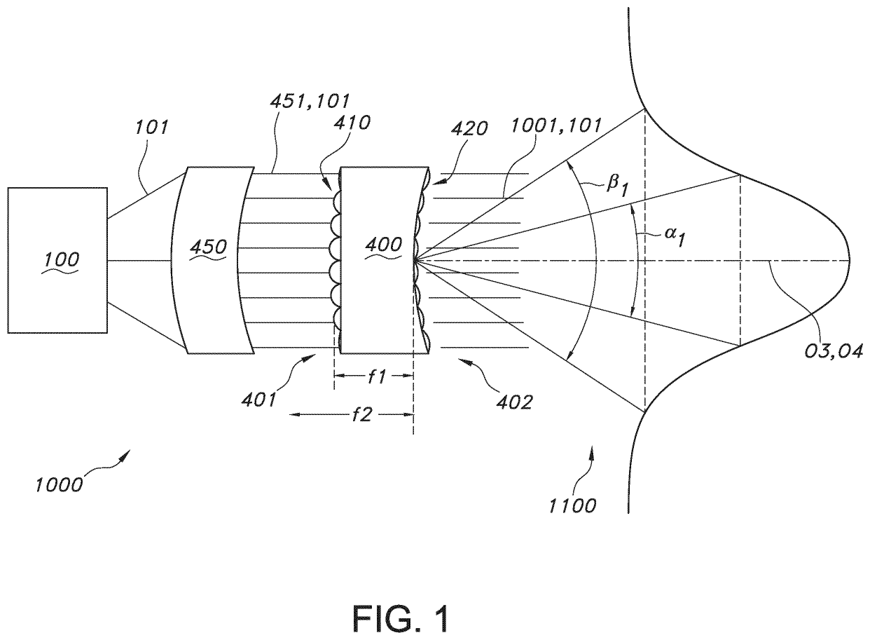

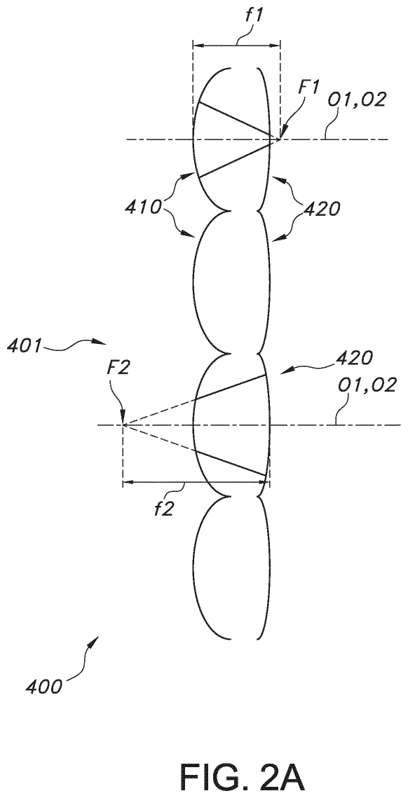

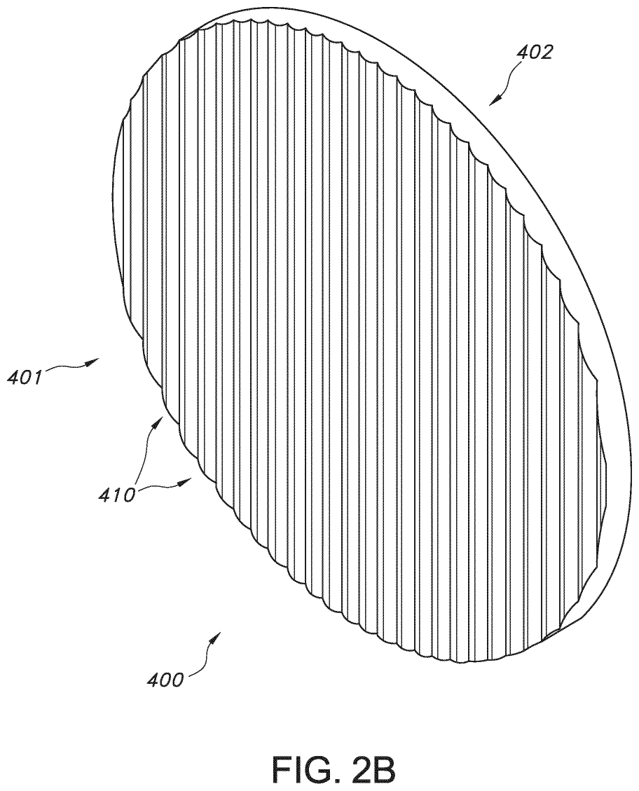

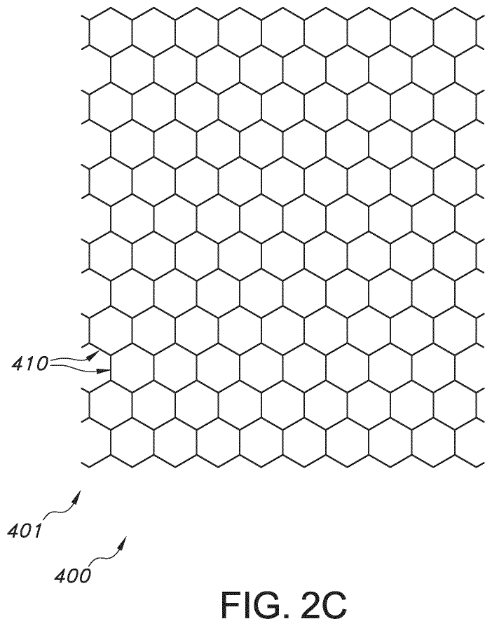

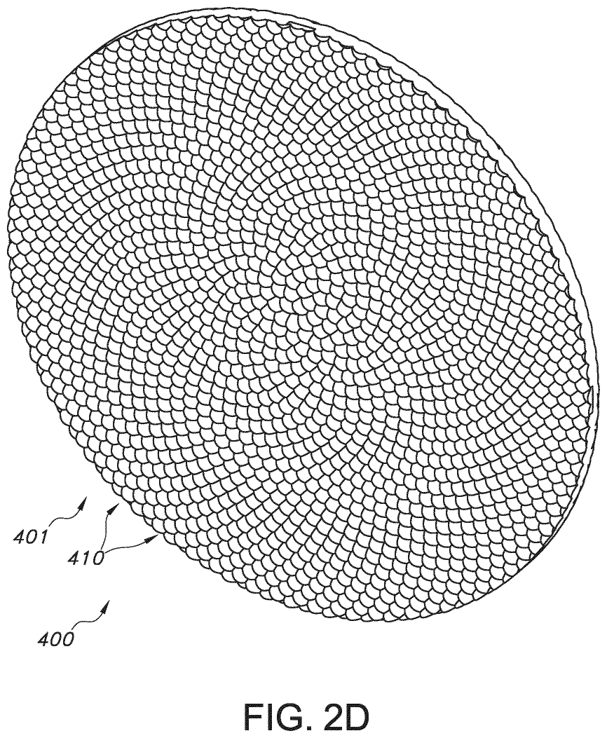

FIG. 1 schematically depicts an embodiment of a light generating system 1000 comprising a light generating device 100 and a lens-based optical element 400. In the depicted embodiment, the light generating device 100 is configured to generate device light 101. Further, in the depicted embodiment, the lens-based optical element 400 comprises a first side 401 and a second side 402, wherein the first side 401 is configured to receive at least part of the device light 101, and wherein the second side 402 is configured downstream of the first side 401 (with respect to the device light). In particular, at the first side 401, the lens-based optical element 400 may comprise a first arrangement comprising a plurality of first lenses 410, which are especially configured in a light-receiving relationship with the light generating device 100. The first lenses 410 may especially have first foci F1 (also see FIG. 2), and may have first focal distances f1. Similarly, at the second side 402, the lens-based optical element 400 may comprise a second arrangement comprising a plurality of second lenses 420, especially configured downstream of the first lenses 410 (with respect to the device light). The second lenses may especially have second foci F2 (see FIG. 2) and may have second focal distances f2. In particular, in the depicted embodiment, the first lenses 410 may be stronger than the second lenses 420, i.e., the first focal distances f1 may be shorter than the second focal distances f2. Hence, in embodiments, f1<f2. In particular, the second lenses 420 may be configured in a range of f1+/−30%, especially in the range of f1+/−20%, such as in the range of f1+/−10%, from the first lenses 410. However, the first lenses 410 may especially be configured external from a range of f2+/−30%, such as from the range of f2+/−20% from the second lenses 420, especially from a range of f2+/−10%. Further, in the depicted embodiment, the light generating system 1000 is configured to generate system light 1001 comprising at least part of the device light 101 downstream of the lens-based optical element 400.

In the depicted embodiment, the first lenses 410 have radially varying first focal distances f1, which thus mutually vary with varying radial distance from the optical axis O3, wherein in FIG. 1 the first focal distances f1 increase with increasing distance from an optical axis O3 of the lens-based optical element 400. In such embodiments, as schematically depicted in FIG. 1, the thickness of the lens-based optical element 400 may also increase with distance to the optical axis O3.

Alternatively, in further embodiments, the first lenses 410 may have radially varying first focal distances f1, wherein the first focal distances f1 decrease with increasing distance from an optical axis O3 of the lens-based optical element 400. In such embodiments, the thickness of the lens-based optical element 400 may also decrease with distance to the optical axis O3.

In the depicted embodiment, the light generating system 1000 further comprises a collimator 450 configured downstream of the light generating device 100 and upstream of the lens-based optical element 400. In such embodiments, the collimator 450 may be configured to provide collimated device light 451,101 to the first side 401 of the lens-based optical element 400.

In principle, any type of collimator 450 may be used. In specific embodiments, the collimator 450 may especially comprise a parabolic mirror. In further embodiments, the collimator may especially comprise a compound parabolic concentrator.

FIG. 1 further schematically depicts a beam 1100 of system light 1001 generated by the light generating device 1000. The beam 1100 may have angle-dependent intensities. In particular, the beam 1100 may have two orthogonally configured full width half maxima (of intensity) and a beam axis (or optical axis) O4, wherein at least one of the full width half maxima has a beam angle al selected from the range of at maximum 70°. Similarly, at least one of the FW10% M may have a beam angle β1 selected from the range of at maximum 110°.

This angle α1 can be selected depending on how much spreading is desired and how good the cut-off should be. For example, with an α1 of about 70° and a FW10% M at about 100° there may be nearly no light at about 60° (or higher). All light above +/−60° can be seen as glare. Hence, this invention may facilitate providing a sharp cut-off, suitable, for instance, for spots and office luminaires.

In further embodiments, the other of the full width half maxima (of intensity) may have a beam angle α2 selected from the range of at maximum 35°. The beam angle α2 is not depicted in FIG. 1. This beam angle would be the beam angle in a plane perpendicular to the plane of drawing, with especially the two planes intersecting at the axes O3 and/or O4.

FIG. 2A schematically depicts an embodiment of the lens-based optical element 400. In the depicted embodiment, the first arrangement of first lenses 410 may be a 2D array of first lenses 410, and the second arrangement of second lenses 420 may be a 2D array of second lenses 420. For visualization purposes only, only a single dimension of the 2D arrays is depicted.

In the depicted embodiment, the first arrangement and the second arrangement may especially be aligned. In particular, the first lenses 410 may have first optical axes O1 and the second lenses 420 may have second optical axes O2, wherein the lens-based optical element 400 comprises a plurality of sets of each a first lens 410 and a respective associated second lens 420, with (especially coinciding) optical axes O1,O2.

FIG. 2B schematically depicts an embodiment wherein the first lenses 410 comprise (first) linear lenses. In such embodiments, the second lenses 420 may especially (also) comprise (second) linear lenses. In particular, the first linear lenses and the second linear lenses may be arranged in optically aligned (to each other).

FIG. 2C schematically depicts an embodiment wherein the first arrangement of first lenses 410 is a first 2D array of first lenses 410. In such embodiments, the second arrangement of second lenses 420 may especially be a second 2D array of second lenses 420. The first lenses and the second lenses may especially be arranged optically aligned (to each other).

FIG. 2D schematically depicts an embodiment wherein the first arrangement of first lenses 410 is a first 2D array of first lenses 410, wherein the first lenses 410 are arranged in a sunflower (tessellation) arrangement. In particular, the sunflower arrangement may facilitate color mixing, and may provide a round beam shape.

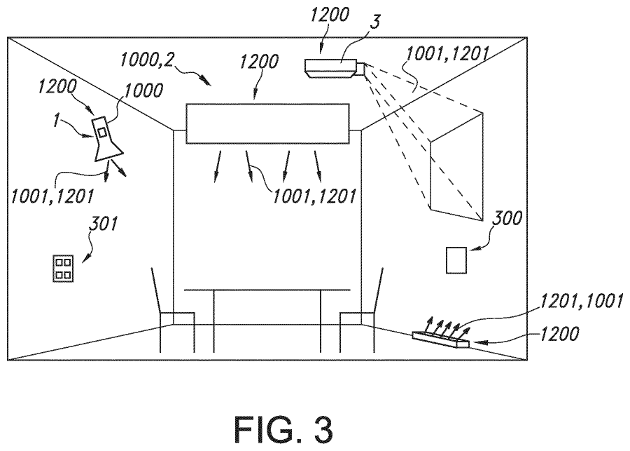

FIG. 3 schematically depicts an embodiment of a lighting device lighting device 1200 selected from the group of a lamp 1, a luminaire 2, a projector device 3, a disinfection device, a photochemical reactor, and an optical wireless communication device, comprising the light generating system 1000 according to any one of the preceding claims.

In particular, FIG. 3 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 3 also schematically depicts an embodiment of a lamp 1 comprising the light generating system 1000. Reference 3 indicates a projector device or projector system, which may be used to project images, such as at a wall, which may also comprise the light generating system 1000. Hence, FIG. 3 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising a light generating device and a lens-based optical element, wherein:
the light generating device is configured to generate device light;
the lens-based optical element comprises a first side configured to receive at least part of the device light, and a second side, configured downstream of the first side, wherein at the first side the lens-based optical element comprises a first arrangement comprising a plurality of first lenses, configured in a light-receiving relationship with the light generating device, and having first focal distances, wherein at the second side the lens-based optical element comprises a second arrangement comprising a plurality of second lenses configured downstream of the first lenses, and having second focal distances; wherein f1<f2, and wherein the following applies: (i) the second lenses (420) are configured at a distance in a range of 0.8*f1-1.2*f1 from the first lenses, and (ii) the first lenses are configured at said distance external from a range of 0.8*f2-1.2*f2 from the second lenses; and
wherein the light generating system is configured to generate system light comprising at least part of the device light downstream of the lens-based optical element, and
wherein the first focal distances of the first lenses mutually vary with varying radial distance from the optical axis.

2. The light generating system according to claim 1, wherein the first lenses comprise linear lenses, and wherein the second lenses comprise linear lenses.

3. The light generating system according to claim 1, wherein the first arrangement comprising first lenses comprises a first 2D array of first lenses, and wherein the second arrangement comprising second lenses comprises a second 2D array of second lenses.

4. The light generating system according to claim 1, wherein the first lenses have first optical axes and wherein the second lenses have second optical axes, wherein the lens-based optical element comprises a plurality of sets of each a first lens and a second lens, with coinciding optical axes.

5. The light generating system according to claim 1, wherein the first focal distances decrease with increasing distance from an optical axis of the lens-based optical element.

6. The light generating system according to claim 1, wherein the first focal distances increase with increasing distance from an optical axis of the lens-based optical element.

7. The light generating system according to claim 1, wherein a thickness of the lens-based optical element varies proportionally with the varying first focal distances with increasing distance from the optical axis.

8. The light generating system according to claim 1, wherein the lens-based optical element is an extruded body.

9. The light generating system according to claim 1, wherein the light generating device comprises one or more solid state light sources, one or more LEDs and/or one or more laser diodes.

10. The light generating system according to claim 1, wherein the light generating device is configured to generate white device light.

11. The light generating system according to claim 1, further comprising a collimator configured downstream of the light generating device and upstream of the lens-based optical element, wherein the collimator is configured to provide collimated device light to the first side of the lens-based optical element.

12. The light generating system according to claim 11, wherein the collimator comprises a compound parabolic concentrator.

13. The light generating system according to claim 1, wherein the light generating system is configured to generate a beam of system light, wherein the beam has two orthogonally configured full width half maxima and a beam axis, wherein at least one of the full width half maxima has a beam angle selected from the range of at maximum 70°.

14. The light generating system according to claim 13, wherein the other of the full width half maxima has a beam angle selected from the range of at maximum 35°.

15. A lighting device selected from the group of a lamp, a luminaire, a projector device, a disinfection device, a photochemical reactor, and an optical wireless communication device, comprising the light generating system according to claim 1.
